(19) United States
(12) Patent Application Publication
(10) Pub. No.: US 2016/0026935 A1
(43) Pub. Date: Jan. 28, 2016

(54) MULTIPLE INDIVIDUAL TRAVEL SCHEDULING

(71) Applicant: International Business Machines Corporation, Armonk, NY (US)

(72) Inventors: Adi I. Botea, Dublin (IE); Radu Marinescu, Dublin (IE)

(21) Appl. No.: 14/339,648

(22) Filed: Jul. 24, 2014

(51) Int. Cl. G06Q 10/02

(52) U.S. Cl. CPC G06Q 10/02

(57) ABSTRACT

Travel planning is provided for a plurality of individuals vying for the use of shared transportation vehicles. A set of travel event requests for the plurality of individuals are accessed as are a set of travel preferences for the plurality of individuals and the travel event requests. Schedules are generated that specify the use of the shared transportation vehicles and that are based upon the set of travel event requests and a tradeoff factor that is derived from scheduling compromises relative to the set of travel preferences. Conflicts are identified, within the schedule and relative to at least one of the shared transportation vehicles, and then presented to at least two individuals. A conflict decision is received from the at least two individuals and the tradeoff factor is modified based upon the conflict decision. The schedule is updated based upon the conflict decision and the tradeoff factor as modified.

### BACKGROUND

The present disclosure relates to travel scheduling, and more specifically, to travel scheduling of multiple parties vying for one or more shared transportation vehicles.

Scheduling and calendaring software can be used to maintain a schedule of events for one or more individuals. Scheduling software can include varying degrees of complexity with features such as a calendar showing appointments and other events for different days and times.

### SUMMARY

According to embodiments, a computer-implemented method is provided for travel planning for a plurality of individuals vying for use of shared transportation vehicles. The method includes accessing, in a memory device, a set of travel event requests for the plurality of individuals; accessing, in a memory device, a set of travel preferences for the plurality of individuals and the travel event requests; generating a schedule, specifying the use of the shared transportation vehicles by the plurality of individuals, based upon the set of travel event requests and a tradeoff factor that is derived from scheduling compromises relative to the set of travel preferences; identifying, within the schedule and relative to at least one of the shared transportation vehicles, a conflict between at least two individuals of the plurality of individuals; presenting the conflict to the at least two individuals; receiving a conflict decision from the at least two individuals; modifying the tradeoff factor relative to the at least two individuals based upon the conflict decision; and updating, in a memory device, the schedule based upon the conflict decision and the tradeoff factor as modified.

Certain embodiments are directed toward a system for travel planning for a plurality of individuals vying for use of shared transportation vehicles. The system can include one or more computer processor circuits that are configured to: access a set of travel event requests for the plurality of individuals; access a set of travel preferences for the plurality of individuals and the travel event requests; generate a schedule, specifying the use of the shared transportation vehicles by the plurality of individuals, based upon the set of travel event requests and a tradeoff factor that is derived from scheduling compromises relative to the set of travel preferences; identify, within the schedule and relative to at least one of the shared transportation vehicles, a conflict between at least two individuals of the plurality of individuals; present the conflict to the at least two individuals; receive a conflict decision from the at least two individuals; modify the tradeoff factor relative to the at least two individuals based upon the conflict decision; and update the schedule based upon the conflict decision and the tradeoff factor as modified.

Embodiments relate to a computer program product for travel planning for a plurality of individuals vying for use of shared transportation vehicles, the computer program product comprising a computer readable storage medium having program instructions embodied therewith, the program instructions executable by at least one computer processor to cause the at least one computer processor to: access, by the at least one computer processor, a set of travel event requests for the plurality of individuals; access, by the at least one computer processor, a set of travel preferences for the plurality of individuals and the travel event requests; generate, by the at least one computer processor, a schedule, specifying the use of the shared transportation vehicles by the plurality of individuals, based upon the set of travel event requests and a tradeoff factor that is derived from scheduling compromises relative to the set of travel preferences; identify, by the at least one computer processor and within the schedule and relative to at least one of the shared transportation vehicles, a conflict between at least two individuals of the plurality of individuals; present, by the at least one computer processor, the conflict to the at least two individuals; receive, by the at least one computer processor, a conflict decision from the at least two individuals; modify, by the at least one computer processor, the tradeoff factor relative to the at least two individuals based upon the conflict decision; and update, by the at least one computer processor, the schedule based upon the conflict decision and the tradeoff factor as modified.

The above summary is not intended to describe each illustrated embodiment or every implementation of the present disclosure.

### BRIEF DESCRIPTION OF THE DRAWINGS

The drawings included in the present application are incorporated into, and form part of, the specification. They illustrate embodiments of the present disclosure and, along with the description, serve to explain the principles of the disclosure. The drawings are only illustrative of certain embodiments and do not limit the disclosure.

FIG. 1 depicts a system diagram for managing travel schedules (plans), consistent with embodiments of the present disclosure;

FIG. 2 depicts a flow diagram for creating and managing travel scheduling, consistent with embodiments of the present disclosure;

FIG. 3 depicts a flow diagram showing parallel schedule processing for multiple individuals, consistent with embodiments of the present disclosure;

FIG. 4 depicts an example set of tradeoff values between individuals, consistent with embodiments of the present disclosure;

FIG. 5 depicts a cloud computing node, according to embodiments of the present disclosure;

FIG. 6 depicts a cloud computing environment, according to embodiments of the present disclosure; and

FIG. 7 depicts abstraction model layers, according to embodiments of the present disclosure.

While the invention is amenable to various modifications and alternative forms, specifics thereof have been shown by way of example in the drawings and will be described in detail. It should be understood, however, that the intention is not to limit the invention to the particular embodiments described. On the contrary, the intention is to cover all modifications, equivalents, and alternatives falling within the spirit and scope of the invention.

### DETAILED DESCRIPTION

Aspects of the present disclosure relate to travel scheduling, more particular aspects relate to travel scheduling for multiple individuals and shared vehicle resources. While the present disclosure is not necessarily limited to such applications, various aspects of the disclosure may be appreciated through a discussion of various examples using this context.

Embodiments of the present disclosure are directed toward computer-implemented system designed to provide travel planning for a plurality of individuals that may be vying for the use of shared transportation vehicles. The system can be configured to generate schedules for different individuals based upon travel event requests submitted for different individuals. The schedules can be generated using individual preferences and parameters such as route preferences, time windows, available modes of transportation, and others. Various aspects are directed toward the use of a tradeoff factor to provide a balanced and fair set of schedules between individuals that may have competing preferences and desires.

Particular embodiments are directed toward a system that is configured to identify potential conflicts between travel schedules of different individuals. For example, multiple individuals may share a vehicle, be part of the same car pool, share responsibilities for transporting a child, or otherwise have transportation needs that can conflict. Potential conflicts might arise when two individuals that would like to use the shared vehicle at similar times or when determining which carpool participant will drive on a particular day. As such, the system can be configured to identify the conflicts that include conflicts for shared resources as well as conflicts caused by mismatches between individual preferences. For example, two members of a family may wish to use the same vehicle (e.g., car) at times that overlap and conflict. In another example, two individuals in car pool may have a preference to drive on the same day.

As discussed herein, the system can be configured to receive, access, and process sets of travel event requests for a plurality of individuals. These travel event requests can include information about the date and time of the event, the starting and end locations for travel, the acceptable modes of travel and other relevant information. For instance, an individual may submit a travel event request to attend a sporting event. The travel request can specify that the sporting event occurs at a particular time, and also specify, where the individual plans to travel from to reach the appropriate venue/location of the sporting event. The system can store a set of such travel event requests in a memory device as a database (e.g., main memory, hard disk drive, volatile or non-volatile memory devices, or the like) for subsequent access.

The system can be configured to store and access a set of travel preferences for individuals, which can be stored in a memory as a database. The travel preferences can be specific to each individual as well as specific to one or more of the travel event requests. For example, various embodiments allow for multi-user travel plans with heterogeneous transportation options and modes (e.g., public transport, shared vehicle and personal vehicles). An individual may have a general preference of driving a personal car instead of using public transportation. This preference may be instituted for all applicable travel event requests. The same individual may have a more specific preference for riding their bike to work, instead of driving a personal car. Thus, the system can determine that travel event requests related to their work would use a different set of preferences.

Based upon the set of travel event requests and travel preferences, the system can generate schedules for the different individuals. The schedules can indicate use of shared transportation vehicles by the individuals and be based upon a tradeoff factor relative to the different individuals. For example, the system can track instances of when individuals are not allocated their first preferences by updating a tradeoff factor value for each individual. This might include, for instance, increasing the tradeoff factor for an individual when one of their preferences is not obtainable due to a conflict with another individual's preference. In subsequent scheduling efforts, the individual with the increased tradeoff factor will be more likely to have their preference met for future conflicts.

Various embodiments are directed toward a conflict resolution process that allows individuals to negotiate and come to an agreement. This can include sending proposed schedules to individuals involved with the scheduling conflict as well as receiving suggestions from the individuals. With this, subscribing individuals whose preferences are not satisfied by a compromise can specify new preferences to be satisfied in the future, as a way to make up for the current preference invalidation. For example, in a car pooling scenario, a first driver may be asked to wait 30 minutes later than their preference due to another carpooling individual having a late meeting. The drivers could reach a compromise where the first driver has his number of designated driver days be reduced by one in a subsequent week.

Certain embodiments provide a mechanism for individuals to communicate their suggested compromises directly to one another, such as through directed emails, text messages or an online forum. This can facilitate their ability to reach a compromise. If a compromise is reached, then the system can update the tradeoff factors for the individuals (e.g., by increasing the tradeoff factor if an individual did not get their preference). If no compromise is reached, the system can select the schedule that was initially proposed and then update the tradeoff factors for the individuals accordingly.

Consistent with embodiments, the system can generate travel and journey schedules/plans for a plurality of subscribers to the system. Plans can be computed for a time interval, such as a month or week. In some embodiments, the system can incrementally generate plans with a granularity of one or more time intervals. Plans of different subscribers can depend on each other because of factors such as shared resources (e.g., a family car), competing preferences, and constraints. According to various embodiments, the system can be designed to generate plans using an algorithm that attempts to generate and select plans that minimize discrepancies between preferences of the subscribers as a whole. In particular examples, the algorithm can analyze series of plans computed for all subscribers for a time interval. The plans can be selected by attempting to evenly balance competing preferences of subscribers. For example, if several subscribers prefer using a shared car that can be used by one subscriber at a time, the system can attempt to assign the car to all users approximately the same number of times.

Consistent with embodiments, a computer system can be configured to select a combination of individual plans (one for each individual/subscriber) that are consistent with one another with respect to shared resources, and particularly, with respect to shared vehicles. Each subscriber can be provided with the corresponding individual plan from the selected combination of plans. The system can allow the subscribers to accept a plan as is, or they can reject the plan by marking it as unacceptable. For example, a plan might be rejected because it conflicts with, or invalidates part of, the subscriber's preferences. If rejected, a tradeoff negotiation can be triggered. The subscribers involved with the rejected plan can initiate negotiation with other subscribers.

For example, if an initial plan invalidates the preference of leaving work on time for an individual (e.g., named Dan). Dan may decide that this could be acceptable if, as part of a compromise, he gets a reduction in the number of driving days. He can present this, and other, options as part of a negotiation with the other individual (e.g., named Stan). If Stan agrees to drive one extra day in the future, a compromise might then be reached. The tradeoff is implemented by modifying the existing preferences, which can be referred to as soft constraints because they are modifiable. Dan's number of driving days is reduced by one and Stan number of driving days is incremented by one. This tradeoff mechanism acts as a way of balancing preferences. Every time a preference is not respected, the set of preferences and constraints can be updated with concrete feedback from subscribers. In certain embodiments weights can be associated with different preferences. Every time a preference is broken, its corresponding tradeoff value can be increased according to the weight. In this way, the specific preference will have a better chance of being respected in the future. As discussed in more detail herein, tradeoff values can also be applied to an individual, generally; and also specifically between different individuals.

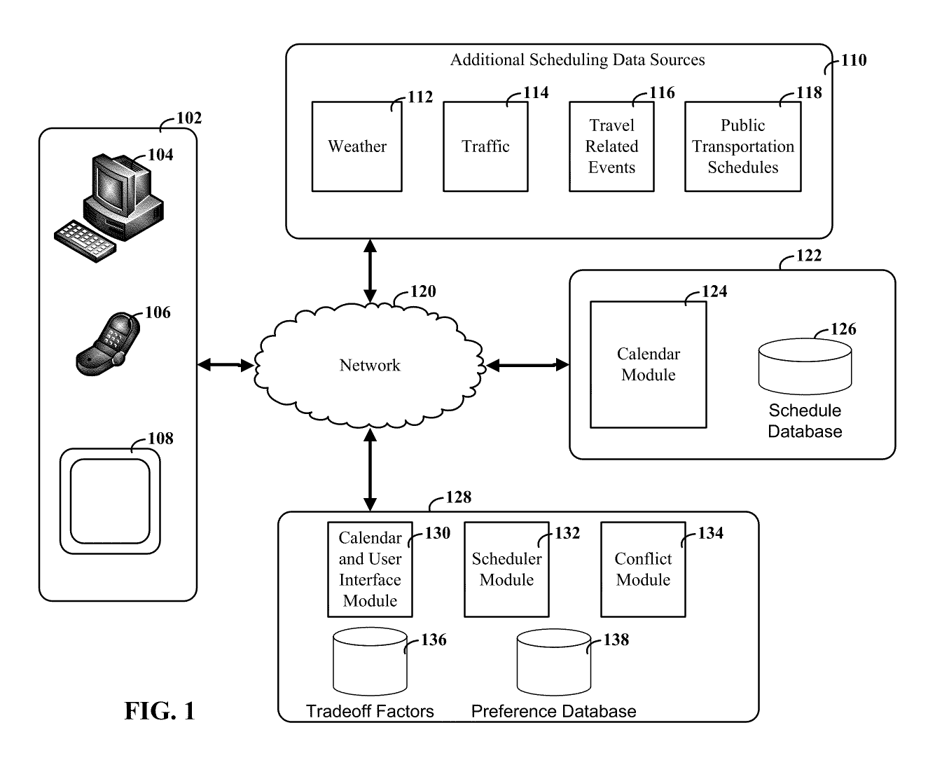

Turning now to the figures, FIG. 1 depicts a system diagram for managing travel schedules, consistent with embodiments of the present disclosure. A set of individuals can access travel management and scheduling services using one or more computer processing devices 102. The computer processing devices 102 can include, but are not limited to, desktop computers 104, smart phones 106 and tablets 108. In various embodiments, the travel scheduling services can be accessed over one or more networks 120. The networks can include, but are not limited to, local area networks, point-to-point communications, wide area networks, the global Internet, and combinations thereof.

In some embodiments, a computer (server) device 128 can be configured to provide travel scheduling services for multiple individuals that may compete for shared vehicles or other travel-related resources. The computer devices and processors discussed herein can include one or more computer processor circuits and storage circuits that can be configured to perform various functions and provide various modules, tools and engines. Moreover, the computer devices can be a single hardware platform or a group of multiple hardware platforms that are part of a distributed (virtual) environment.

Computer device 128 can include a calendar and user interface module 130, which can be configured to communicate with calendaring applications 124 and with the devices 102, of the individuals using the service. For instance, user interface module 130 can provide a web interface that allows multiple individuals to access the travel scheduling services from the Internet. The interface module 130 can also be configured to generated schedules that are formatted according to a format accepted by a particular calendar application. For example, the interface module 130 can be configured to generate schedules in the form of Comma Separated Values (CSV) files, which have a comma between each item of information.

In certain embodiments, computer device 128 can also include a scheduler module 132. The scheduler module 132 can be configured to analyze and process various travel event requests for the multiple individuals. The travel event requests represent travel plans for the individuals and can also specify associated events, preferences and other information. For instance, an individual can create a travel event request for traveling to and from their place of work. This event request may specify travel events for mornings and evenings (e.g., leaving and arriving at work at 8 AM and 5 PM, respectively) on work days (e.g., Monday-Friday). The travel event request may also specify, or be linked to, acceptable and preferred modes of transportation (e.g., car, public transportation, or walking). For example, travel mode preferences for the individuals can be stored in a preference database 138.

The scheduler module 132 can receive and process travel event requests for multiple individuals and over a particular discrete time period (e.g., daily, weekly or monthly). As discussed herein, the scheduler module 132 can use tradeoff factors, stored in memory device as tradeoff factors database 136, to balance the fairness of the created the schedules. Moreover, the scheduling process can lead to potential conflicts between the scheduled plans of different individuals. The conflicts can include travel event requests that each specify use of a particular vehicle during the same time period. The conflicts might also include conflicts involving shared responsibilities. For example, parents may share the responsibility of picking up a child from school. One or more travel event requests that conflict with the normally scheduled pickup might result in a conflict relating to which parent picks up the child on a particular day.

Conflict module 134 can be configured to detect and handle conflicts between various individuals. Detection of conflicts can include identifying overlapping reservations for vehicles or for duties of the individuals. The detection can also take into consideration the resulting location of the vehicles caused by proposed schedules. For example, the location of a family car after its use by a first family member can be considered when determining whether or not it would be available for subsequent use by other family members.

In certain embodiments, the conflict module 134 can be configured to provide one or more candidate/proposed schedules to the multiple individuals. The proposed schedules may highlight the conflicts as well as the a few possible resolutions. For example, the conflict module 134 can send an email with a viewable schedule (or a link to a web accessible schedule) to the affected individuals. Detected conflicts can be marked for the affected individuals to accept, reject or counter propose.

Consistent with various embodiments, the scheduler module 132 can use various sources of additional information to generate candidate schedules. For instance, computer device(s) 110 can include a variety of different scheduling data sources. In certain instances, one or more of the data sources can be external or third party sources. The information types can include, but are not limited to, weather 112, traffic 114 (e.g., traffic reports), travel/transportation related events 116 (e.g., construction or sporting events), and public transportation schedules 118 (e.g., buses, subways and trains). For example, a travel event request may specify a desire that an individual be at a particular address near a baseball stadium at 5:00 PM. The system can check the travel related event services/modules to identify that a baseball game is finishing around 5:00 PM and deduce that additional time will be needed to get to the particular address. The additional time might then result in a new conflict being detected. In certain embodiments, preferences of the individuals may be linked to things like weather. For example, a person might prefer walking to work unless it is raining or below a certain temperature, in which case their preference could be to drive a personal car to work.

Another computer (server) device 122 can provide calendaring functions using a calendar module 124 and schedule database 126. For instance, a web accessible calendar service can allow individuals to see scheduled events as well as provide automated reminders for events (e.g., via email, test messages or otherwise). In some instances, the calendar service can also be accessible through calendaring specific programs, such as productivity software suites that might also provide services such as email or the like.

Various aspects of the present disclosure can be more readily understood in the context of non-limiting examples. For instance, at the beginning of a given interval, or at any other time, subscribers can indicate their mobility/transportation requests using an electronic agenda or calendar service 124. For example, an individual (Dan) may mark that every working day he has to be at work by 9 am, and leave work by 5 pm. The system can partition scheduling according to time intervals using units such as the morning of each day (when subscribers go from home to work or school) and the second half of each day (when the subscribers return home). Plans can then be computed for each time unit separately.

The separation of planning into different time units allows for the computation of plans to be postponed in order to make use of the most recent data available, such as public transport information and weather information. Moreover, the system can use updated preferences obtained as a result of trade-off negotiation performed in previous discrete time units (e.g., in previous days) to create subsequent schedules. This can help to fairly apportion scheduling preferences between different individuals. For example, when Dan requires a reduction in the number of driving days, the system can update the preferences accordingly, and planning for all subsequent discrete time units will use an updated set of preferences. This may also result in a change in a tradeoff factor for the affected individuals. The tradeoff factor can then be used to determine which individual's preference is honored when conflicts arise.

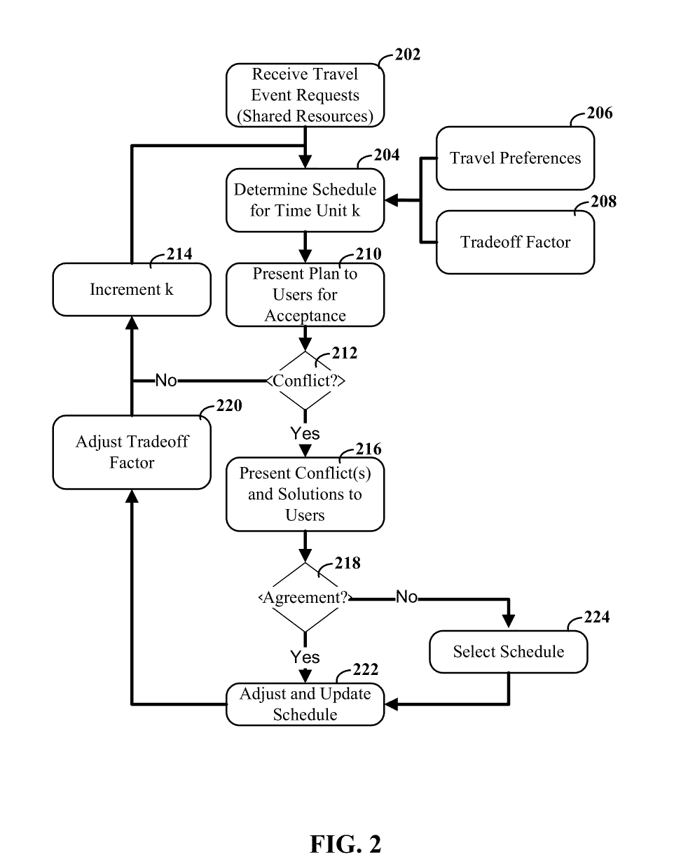

FIG. 2 depicts a flow diagram for creating and managing travel scheduling, consistent with embodiments of the present disclosure. The flow diagram can be carried out using one or more computer processors and systems, such as those discussed in connection with FIG. 1. Consistent with various embodiments, individuals can provide travel event requests to the system, per block 202. For example, providing travel event requests include adding travel events on a calendar program that is linked to a travel scheduling/managing module. It may also include providing travel event data directly to the travel scheduling module.

Given a discrete time interval/unit “k” (e.g., a day or part of a day), embodiments relate to a system that is configured to determine a schedule for the various individuals, per block 204. As an example of how a schedule can be determined, the system can first generate a set of candidate plans for a subscriber/individual. The set of candidate plans can be filtered or reduced according to tradeoff factors 208 and different preferences and objectives of the individual 206, such as the monetary cost and the comfort.

According to embodiments, the candidate plans can then be presented to the various individual users, per block 210. In some embodiments, each subscriber can be allowed to rank their own candidate plans and/or the system can assign a default ranking automatically. Based upon the selections and rankings, the system can determine whether or not there is a possible conflict, per block 212. For example, a conflict might be identified if a vehicle is desired by two different individuals at times and places that are inconsistent. Another conflict might be identified when multiple individuals have responsibility to perform a task (e.g., drive for a carpool to work) and have preferences that might conflict (e.g., no individual wants to drive on Mondays). If no conflict is identified (e.g., all individuals accept the proposed schedules), then the system can increment the discrete time unit “k,” per block 214. The system can then determine schedules for the new time unit, per block 204.

If a conflict has been identified, then the system can identify one or more solutions to the conflict. These solutions can then be presented to the affected users, per block 216. For example, if two siblings wish to use the family boat on a Saturday, the system may suggest options such as: one sibling gets to use the boat while the other has access to the car for the following week; one sibling gets the boat in the morning and the other in the evening, or both siblings share the boat for the day with each being able to bring fewer of their respective friends than if they had use of the boat alone. These, and other, potential solutions can be presented to the siblings. Moreover, in some embodiments, the affected individuals can suggest solutions. For instance, one of the siblings in the boat example might suggest allowing the other to use the boat for the contested weekend in exchange for getting the right to use the boat for the next two weekends. The suggestion can be presented to the other sibling for approval, per block 216.

The system can check whether or not an agreement has been reached, per block 218. If an agreement has been reached, the system can adjust the schedule accordingly, per block 222. If an agreement has not been reached, the system can select a schedule to implement, per block 224. As this schedule has not been approved by all individuals, the system can be configured to select a schedule that attempts to fairly balance competing preferences and schedule requirements of the affected individuals. For instance, the system may attempt to find and select the option that minimizes the number of preferences that are not met across all individuals.

Once a schedule has been selected, either through an express agreement or system selection, the schedules can be adjusted and updated, per block 222. This may include, for instance, uploading the scheduled events, from the selected schedules, to one or more calendaring services for the various users.

The system can then adjust and update tradeoff factors for the individuals, per block 220. For instance, if a first individual compromised on their preferences in favor of another individual's preferences, then the first individual can have their tradeoff factor increased. As discussed herein, the tradeoff factor can be used to increase the likelihood that the individual will have their preferences honored relative to potential conflicts with other individuals with lower tradeoff factors. This can improve the fairness of the allocation of shared vehicles because prior allocations are tracked to allow for each individual to be given opportunities to use the shared vehicles.

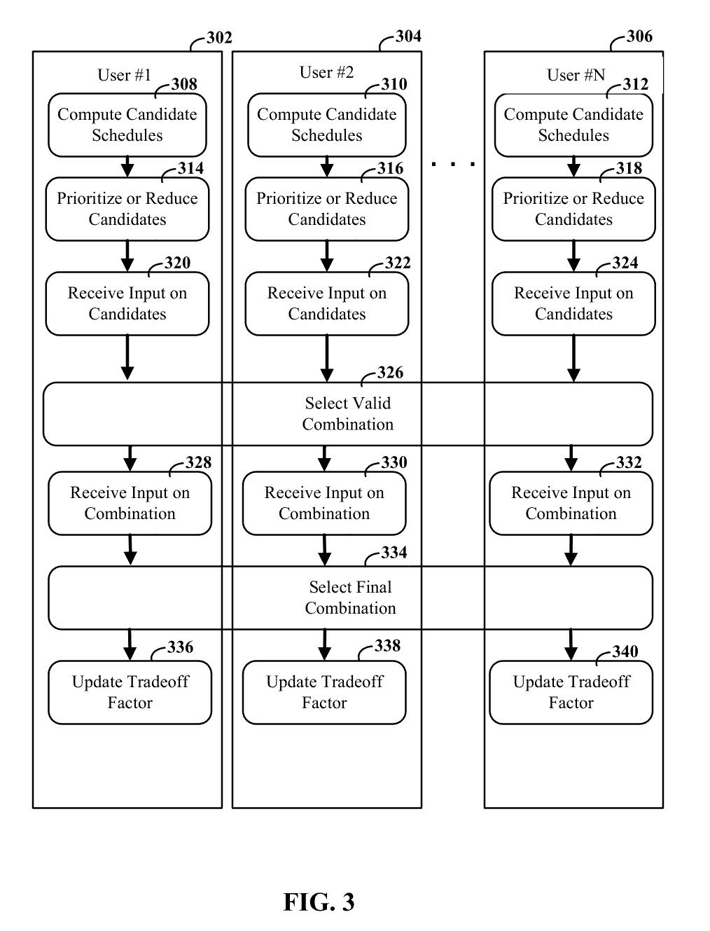

FIG. 3 depicts a flow diagram showing parallel schedule processing for multiple individuals, consistent with embodiments of the present disclosure. According to embodiments, the system can be configured to process schedules and travel event requests from a plurality of individuals/users 302, 304, 306. The processing can be carried out using one or more computer processors and devices, such as those discussed in connection with FIG. 1. This can include first computing candidate schedules for each of the users, per blocks 308, 310, and 312. The system can then be configured to prioritize, reduce, or both prioritize and reduce, the candidate schedules for the users, per blocks 314, 316, and 318. This may include calculating a score for the plans as a function of plan objectives and preferences. For instance, values can be assigned to different preferences associated with travel event requests (e.g., different modes of travel can be given different values), deviations from a preferred time can be assigned preference values (e.g., every 10 minutes from ideal time can be given a value), having to perform a duty can be assigned values (e.g., every time a parent is asked to pick up a child a value can be calculated), and combinations thereof. The resulting scores can be used to remove candidate schedules with poor scores (e.g., that do not meet very many preferences) and to order or prioritize the remaining schedules.

Consistent with certain embodiments, the individuals can provide input on the candidate schedules, per blocks 320, 322, and 324. This might include ordering of schedules according to their personal preferences, removing candidate schedules that are unacceptable, and modifying one or more of the candidate schedules to create a new candidate schedule. The system can then take the remaining candidate schedules and attempt to select one or more valid combinations of individual plans, per block 334.

Consistent with embodiments, the selection can be made using one or more schedule selection algorithms that are designed to attempt to optimize the preference and tradeoff values across the set of users. For instance, the preference values for each individual can be determined based upon by deviations from their individually-selected preferences. Tradeoff values for each individual can be determined based upon previous compromises in which individuals did not get their preferences met by a selected schedule. For example, the system can be configured to compute schedules for discrete time units, as discussed in more detail herein. During schedule computation in a previous time unit, user #2 may have preferred to use a family car, but had to use public transportation instead due to another user being scheduled to use the car. The system can therefore increase the tradeoff value for user #2. This increased tradeoff value can be used to increase the weight of preferences for user #2 so that the algorithms are more likely to favor user #2's preferences in scheduling decisions for subsequent time units.

Consistent with certain embodiments, the schedule selection algorithm(s) can consider both hard and soft constraints. For example, a hard constraint may be that a child must be picked up before their daycare closes. An example of soft constraint may be a preference to use the car to go to an athletic center workout in the morning instead of in the evening. The system can select candidate schedules that might break soft constraints, while rejection schedules that break hard constraints.

In some embodiments, the schedule selection algorithm can allow for the schedules to be modified such that one or more iterative optimization algorithms can further refine and select candidate schedules. A few non-limiting examples include hill-climbing (including stochastic and other variants), Newton methods, and gradient methods that can be used to select optimal parameters for the schedules. For example, soft constraints may allow for incremental changes to scheduled timing of different travel event requests. A hill-climbing algorithm can be employed to iterative search for timings of the various events that result in improved preference matching for the group of individual users.

Based upon the schedule selection algorithm, one or more combination of individual schedules can be presented to the users, per blocks 328, 330 and 332. In some instances, the system may highlight, or otherwise indicate, that a conflict exists. Using the various selection processes discussed herein, the system can select a final combination of schedules, per block 334. For example, the system can allow individuals to negotiate and then confirm a combination of schedules. If the negotiation fails, the system can select a combination for the users based upon the results of the scheduling selection algorithm. In either event, the system can then update tradeoff factors for the users, per block 336.

Consistent with various embodiments, a tradeoff factor value can be associated with each preference of an individual. For instance, a first individual may prefer to leave work at 5 PM, but have to wait until 6 PM because another individual has to work late. The tradeoff factor for work time can be increased. This can then translate into the system moving future carpool times toward the first individual's preferences, selecting other individuals to drive extra days, or other schedule selections that favor preferences of the first individual.

In particular embodiments, the tradeoff factor value(s) can be specific between two or more individuals. For example, the system could store tradeoff factors between each individual so that future potential conflicts between the individuals will take into consideration past compromises; however, future potential conflicts with another individual will not favor any particular individual. This can be particularly useful for avoiding unfairly disadvantaging an individual that was not involved, and did not receive any benefit from, a compromise between two or more other individuals.

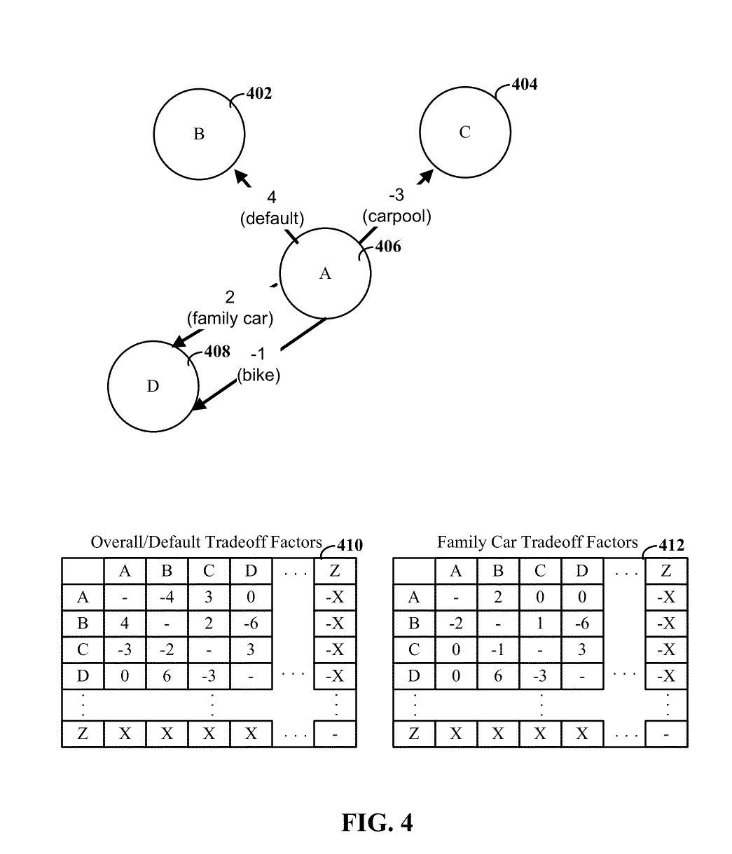

FIG. 4 depicts an example set of tradeoff values between individuals, consistent with embodiments of the present disclosure. Individuals 402 (B), 404 (C), 406 (A) and 408 (D) are graphically represented by circles. Example tradeoff values between individual A and individuals B, C, and D are represented by arrows. For example, individual A may participate in a carpool with individual C, share family vehicles with individual B and have only a loose relationship with individual B. Accordingly, a tradeoff value for the carpool can be tracked for individual C. Similarly, a tradeoff value for family-shared vehicles can be tracked for individual D. In this case, the family shares both a car and a bike. A default tradeoff value can be assigned to individual B and applied to any conflict. Although not depicted, a default tradeoff value can be maintained between all individuals and used for conflicts that have not been assigned a dedicated tradeoff value.

When potential conflicts are detected, the system can use an algorithm that factors in the appropriate tradeoff value(s) for the conflict. As an example, a positive tradeoff value may represent that the corresponding individual's preferences should be given more weight in selecting a schedule. For example, individual A should be given preference over individual B for a conflict involving the family car; however, individual B should be given preference over individual A for a conflict involving the shared bike.

Tradeoff factor tables 410 and 412 provide examples of tradeoff factor values relative to a set of individuals A-Z. For each of the tables, the values in lower left are from the perspective of the individual indicated in the corresponding row, while the values in the upper right are from the perspective of the individual indicated in the corresponding column. For example, individual D is favored in the overall/default table 410 by a factor of 6 relative to individual B, while individual B is favored over individual A by a factor of 4. Whereas individual A is favored over individual B with reference to the shared family car, as shown by the table 412. Accordingly, for conflicts that do not involve the shared family car, individual B would receive an advantage in the scheduling algorithm; however, individual A would receive the advantage if the conflict involved the family car.

In some embodiments, a conflict may involve more than one tradeoff factor (e.g., more than one shared vehicle or more than two individuals). For such instances, the algorithm can apply the different tradeoff factors to each aspect of the conflict and attempt to find a solution that attempts to fairly balance competing preferences while taking into consideration past compromises.

It is understood in advance that although this disclosure includes a detailed description on cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g. networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure comprising a network of interconnected nodes.

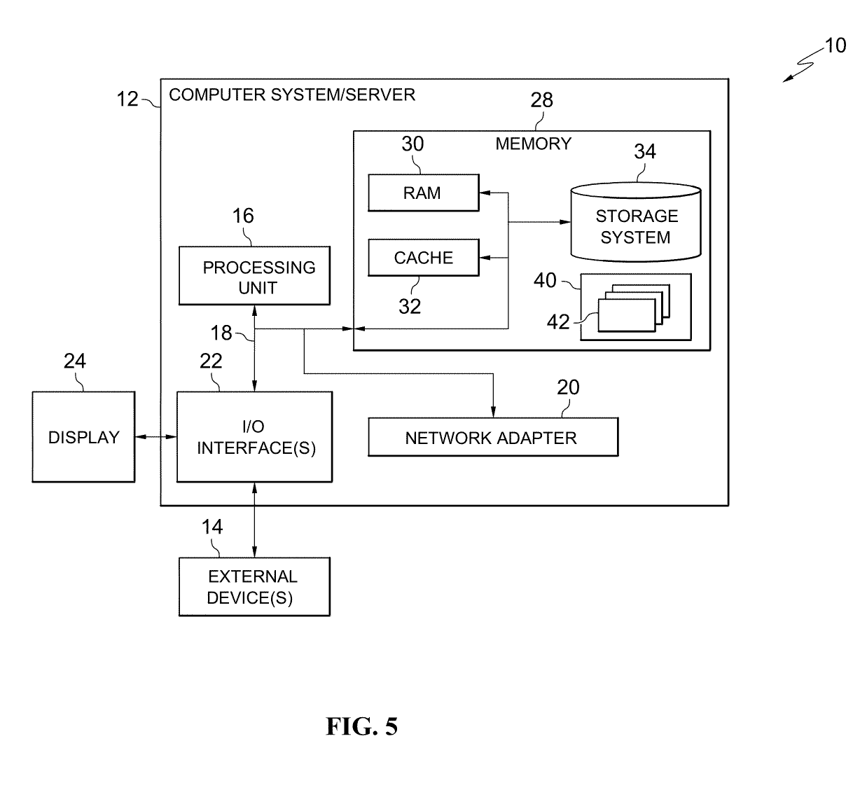

Referring now to FIG. 5, a schematic of an example of a cloud computing node is shown. Cloud computing node 10 is only one example of a suitable cloud computing node and is not intended to suggest any limitation as to the scope of use or functionality of embodiments of the invention described herein. Regardless, cloud computing node 10 is capable of being implemented and/or performing any of the functionality set forth hereinabove.

In cloud computing node 10 there is a computer system/server 12, which is operational with numerous other general purpose or special purpose computing system environments or configurations. Examples of well-known computing systems, environments, and/or configurations that may be suitable for use with computer system/server 12 include, but are not limited to, personal computer systems, server computer systems, thin clients, thick clients, hand-held or laptop devices, multiprocessor systems, microprocessor-based systems, set top boxes, programmable consumer electronics, network PCs, minicomputer systems, mainframe computer systems, and distributed cloud computing environments that include any of the above systems or devices, and the like.

Computer system/server 12 may be described in the general context of computer system-executable instructions, such as program modules, being executed by a computer system. Generally, program modules may include routines, programs, objects, components, logic, data structures, and so on that perform particular tasks or implement particular abstract data types. Computer system/server 12 may be practiced in distributed cloud computing environments where tasks are performed by remote processing devices that are linked through a communications network. In a distributed cloud computing environment, program modules may be located in both local and remote computer system storage media including memory storage devices.

As shown in FIG. 5, computer system/server 12 in cloud computing node 10 is shown in the form of a general-purpose computing device. The components of computer system/server 12 may include, but are not limited to, one or more processors or processing units 16, a system memory 28, and a bus 18 that couples various system components including system memory 28 to processor 16.

Bus 18 represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus.

Computer system/server 12 typically includes a variety of computer system readable media. Such media may be any available media that is accessible by computer system/server 12, and it includes both volatile and non-volatile media, removable and non-removable media.

System memory 28 can include computer system readable media in the form of volatile memory, such as random access memory (RAM) 30 and/or cache memory 32. Computer system/server 12 may further include other removable/non-removable, volatile/non-volatile computer system storage media. By way of example only, storage system 34 can be provided for reading from and writing to a non-removable, non-volatile magnetic media (not shown and typically called a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to bus 18 by one or more data media interfaces. As will be further depicted and described below, memory 28 may include at least one program product having a set (e.g., at least one) of program modules that are configured to carry out the functions of embodiments of the invention.

Program/utility 40, having a set (at least one) of program modules 42, may be stored in memory 28 by way of example, and not limitation, as well as an operating system, one or more application programs, other program modules, and program data. Each of the operating system, one or more application programs, other program modules, and program data or some combination thereof, may include an implementation of a networking environment. Program modules 42 generally carry out the functions and/or methodologies of embodiments of the invention as described herein.

Computer system/server 12 may also communicate with one or more external devices 14 such as a keyboard, a pointing device, a display 24, etc.; one or more devices that enable a user to interact with computer system/server 12; and/or any devices (e.g., network card, modem, etc.) that enable computer system/server 12 to communicate with one or more other computing devices. Such communication can occur via Input/Output (I/O) interfaces 22. Still yet, computer system/server 12 can communicate with one or more networks such as a local area network (LAN), a general wide area network (WAN), and/or a public network (e.g., the Internet) via network adapter 20. As depicted, network adapter 20 communicates with the other components of computer system/server 12 via bus 18. It should be understood that although not shown, other hardware and/or software components could be used in conjunction with computer system/server 12. Examples, include, but are not limited to: microcode, device drivers, redundant processing units, external disk drive arrays, RAID systems, tape drives, and data archival storage systems, etc.

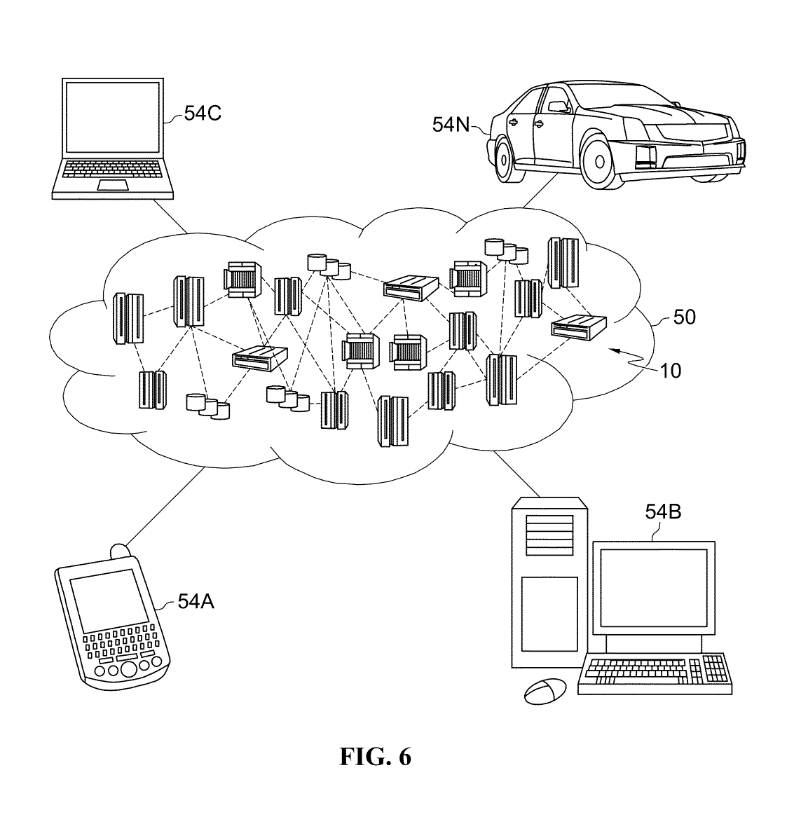

Referring now to FIG. 6, illustrative cloud computing environment 50 is depicted. As shown, cloud computing environment 50 comprises one or more cloud computing nodes 10 with which local computing devices used by cloud consumers, such as, for example, personal digital assistant (PDA) or cellular telephone 54A, desktop computer 54B, laptop computer 54C, and/or automobile computer system 54N may communicate. Nodes 10 may communicate with one another. They may be grouped (not shown) physically or virtually, in one or more networks, such as Private, Community, Public, or Hybrid clouds as described hereinabove, or a combination thereof. This allows cloud computing environment 50 to offer infrastructure, platforms and/or software as services for which a cloud consumer does not need to maintain resources on a local computing device. It is understood that the types of computing devices 54A-N shown in FIG. 6 are intended to be illustrative only and that computing nodes 10 and cloud computing environment 50 can communicate with any type of computerized device over any type of network and/or network addressable connection (e.g., using a web browser).

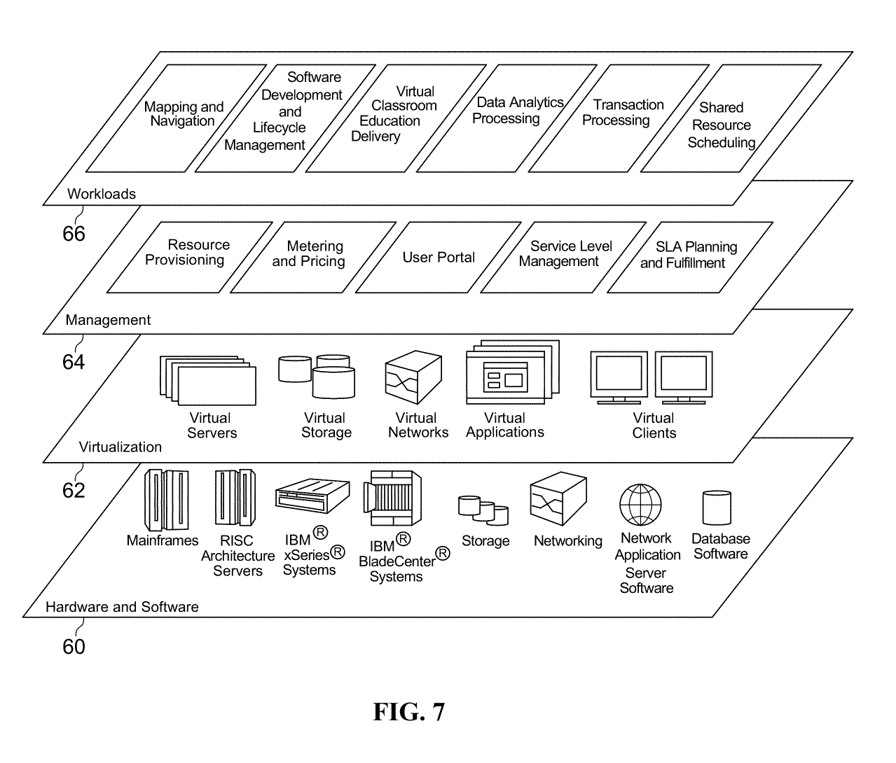

Referring now to FIG. 7, a set of functional abstraction layers provided by cloud computing environment 50 (FIG. 6) is shown. It should be understood in advance that the components, layers, and functions shown in FIG. 7 are intended to be illustrative only and embodiments of the invention are not limited thereto. As depicted, the following layers and corresponding functions are provided:

Hardware and software layer 60 includes hardware and software components. Examples of hardware components include mainframes, in one example IBM® zSeries® systems; RISC (Reduced Instruction Set Computer) architecture based servers, in one example IBM pSeries® systems; IBM xSeries® systems; IBM BladeCenter® systems; storage devices; networks and networking components. Examples of software components include network application server software, in one example IBM WebSphere® application server software; and database software, in one example IBM DB2® database software. (IBM, zSeries, pSeries, xSeries, BladeCenter, WebSphere, and DB2 are trademarks of International Business Machines Corporation registered in many jurisdictions worldwide).

Virtualization layer 62 provides an abstraction layer from which the following examples of virtual entities may be provided: virtual servers; virtual storage; virtual networks, including virtual private networks; virtual applications and operating systems; and virtual clients.

In one example, management layer 64 may provide the functions described below. Resource provisioning provides dynamic procurement of computing resources and other resources that are utilized to perform tasks within the cloud computing environment. Metering and Pricing provide cost tracking as resources are utilized within the cloud computing environment, and billing or invoicing for consumption of these resources. In one example, these resources may comprise application software licenses. Security provides identity verification for cloud consumers and tasks, as well as protection for data and other resources. User portal provides access to the cloud computing environment for consumers and system administrators. Service level management provides cloud computing resource allocation and management such that required service levels are met. Service Level Agreement (SLA) planning and fulfillment provide pre-arrangement for, and procurement of, cloud computing resources for which a future requirement is anticipated in accordance with an SLA.

Workloads layer 66 provides examples of functionality for which the cloud computing environment may be utilized. Examples of workloads and functions which may be provided from this layer include: mapping and navigation; software development and lifecycle management; virtual classroom education delivery; data analytics processing; and transaction processing; mobile desktop; and shared resource scheduling.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of the present disclosure have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to explain the principles of the embodiments, the practical application or technical improvement over technologies found in the marketplace, or to enable others of ordinary skill in the art to understand the embodiments disclosed herein.

What is claimed is:

1. A computer-implemented method for travel planning for a plurality of individuals vying for use of shared transportation vehicles, the method comprising:
accessing, in a memory device, a set of travel event requests for the plurality of individuals;
accessing, in a memory device, a set of travel preferences for the plurality of individuals and the travel event requests;
generating a schedule, specifying the use of the shared transportation vehicles by the plurality of individuals, based upon the set of travel event requests and a tradeoff factor that is derived from scheduling compromises relative to the set of travel preferences;
identifying, within the schedule and relative to at least one of the shared transportation vehicles, a conflict between at least two individuals of the plurality of individuals;
presenting the conflict to the at least two individuals;
receiving a conflict decision from the at least two individuals;
modifying the tradeoff factor relative to the at least two individuals based upon the conflict decision; and
updating the schedule in a memory device and based upon the conflict decision and the tradeoff factor as modified.

2. The method of claim 1, wherein generating the schedule includes applying an algorithm that uses values corresponding to the set of travel preferences to calculate the tradeoff factor.

3. The method of claim 2, wherein the algorithm is configured to schedule use of shared transportation vehicles in a manner that attempts to optimize the tradeoff factor.

4. The method of claim 1, further comprising:
receiving a request to modify the schedule from an individual of the plurality of individuals;
updating the schedule based upon the request to modify the schedule;
identifying another conflict; and
updating the schedule based upon another conflict decision and modifications to the tradeoff factor resulting from the other conflict decision.

5. The method of claim 1, further comprising identifying compromises that are based upon scheduling the use of a shared transportation vehicle that is not a first preference for at least one of the plurality of individuals.

6. The method of claim 1, further comprising:
receiving, after updating the schedule, environment event data relating to at least one event from the set of travel event requests;
modifying, in response to the environment event data, the at least one event in the schedule;
modifying the tradeoff factor relative to an individual affected by modifying the at least one event; and
updating the schedule based upon the tradeoff factor as modified.

7. The method of claim 1, wherein the set of travel preferences include a ranking of different modes of travel for a particular travel event.

8. The method of claim 1, wherein identifying the conflict includes analyzing a location of a shared vehicle relative to a travel event request specifying use of the shared vehicle.

9. The method of claim 1, further comprising formatting the schedule according to a particular calendar application and submitting the schedule to the particular calendar application.

10. A system for travel planning for a plurality of individuals vying for use of shared transportation vehicles, the system comprising:
one or more computer processor circuits configured to:
access a set of travel event requests for the plurality of individuals;
access a set of travel preferences for the plurality of individuals and the travel event requests;
generate a schedule, specifying the use of the shared transportation vehicles by the plurality of individuals, based upon the set of travel event requests and a tradeoff factor that is derived from scheduling compromises relative to the set of travel preferences;
identify, within the schedule and relative to at least one of the shared transportation vehicles, a conflict between at least two individuals of the plurality of individuals;
present the conflict to the at least two individuals;
receive a conflict decision from the at least two individuals;
modify the tradeoff factor relative to the at least two individuals based upon the conflict decision; and
update the schedule based upon the conflict decision and the tradeoff factor as modified.

11. The system of claim 10, wherein the one or more computer processor circuits are further configured to generate the schedule by applying an algorithm that is configured to use values corresponding to the set of travel preferences to calculate the tradeoff factor.

12. The system of claim 11, wherein the algorithm is configured to schedule use of shared transportation vehicles in a manner that attempts to optimize the tradeoff factor.

13. The system of claim 10, wherein the one or more computer processor circuits are further configured to:
receive a request to modify the schedule from an individual of the plurality of individuals;
update the schedule based upon the request to modify the schedule;
identify another conflict; and
update the schedule based upon another conflict decision and modifications to the tradeoff factor resulting from the other conflict decision.

14. The system of claim 10, wherein the one or more computer processor circuits are further configured to identify a compromise that is based upon scheduling the use of a shared transportation vehicle that is not a first preference for at least one of the plurality of individuals.

15. The system of claim 10, wherein the one or more computer processor circuits are further configured to:
receive, after updating the schedule, environment event data relating to at least one event from the set of travel event requests;
modify, in response to the environment event data, the at least one event in the schedule;
modify the tradeoff factor relative to an individual affected by modifying the at least one event; and
update the schedule based upon the tradeoff factor as modified.

16. The system of claim 10, wherein the set of travel preferences include a ranking of different modes of travel for a particular travel event.

17. The system of claim 10, wherein identifying the conflict includes analyzing a location of a shared vehicle relative to a travel event request specifying use of the shared vehicle.

18. The system of claim 10, wherein the one or more computer processor circuits are further configured to: format the schedule according to a particular calendar application and submit the schedule to the particular calendar application.

19. A computer program product for travel planning for a plurality of individuals vying for use of shared transportation vehicles, the computer program product comprising a computer readable storage medium having program instructions embodied therewith, the program instructions executable by at least one computer processor to cause the at least one computer processor to:
access, by the at least one computer processor, a set of travel event requests for the plurality of individuals;
access, by the at least one computer processor, a set of travel preferences for the plurality of individuals and the travel event requests;
generate, by the at least one computer processor, a schedule, specifying the use of the shared transportation vehicles by the plurality of individuals, based upon the set of travel event requests and a tradeoff factor that is derived from scheduling compromises relative to the set of travel preferences;
identify, by the at least one computer processor and within the schedule and relative to at least one of the shared transportation vehicles, a conflict between at least two individuals of the plurality of individuals;
present, by the at least one computer processor, the conflict to the at least two individuals;
receive, by the at least one computer processor, a conflict decision from the at least two individuals;
modify, by the at least one computer processor, the tradeoff factor relative to the at least two individuals based upon the conflict decision; and
update, by the at least one computer processor, the schedule based upon the conflict decision and the tradeoff factor as modified.
